(19) United States
(12) Patent Application Publication
(10) Pub. No.: US 2016/0169474 A1
(43) Pub. Date: Jun. 16, 2016

(54) Acrylate-Fluoro Polymeric Components for Lighting Systems and Method Therefor

(71) Applicant: GE LIGHTING SOLUTIONS, LLC, East Cleveland, OH (US)

(72) Inventors: Dengke Cai, Willoughby, OH (US); Gary Robert Allen, Chesterland, OH (US); Mark Edward Kaminski, Beachwood, OH (US); Benjamin Lee Yoder, Cleveland Heights, OH (US)

(21) Appl. No.: 14/569,902

(22) Filed: Dec. 15, 2014

(51) Int. Cl. F21V 3/04; F21V 5/04

(52) U.S. Cl. CPC F21V 3/0445; F21V 5/04; F21Y 2101/02

(57) ABSTRACT

A lighting system that includes a light source that generates electromagnetic radiation including visible light and ultraviolet radiation, and a molded component formed of an optically translucent or transparent acrylate-fluoro copolymer or blend containing a fluoropolymer and an acrylate polymer. The acrylate polymer has a visible light total transmissivity that is lower than the visible light total transmissivity of the fluoropolymer, and each of the fluoropolymer and the acrylate-fluoro copolymer or blend has a limiting oxygen index that is higher than a limiting oxygen index of the acrylate polymer.

### BACKGROUND OF THE INVENTION

The present invention generally relates to lighting systems and related technologies. More particularly, this invention relates to optically translucent or transparent materials suitable for use in lighting systems, a particular example of which is light-emitting diode (LED) lamps.

LED lamps (bulbs) provide a variety of advantages over more traditional incandescent and fluorescent lamps, including but not limited to a longer life expectancy, high energy efficiency, and full brightness without requiring time to warm up. As known in the art, LEDs (which as used herein also encompasses organic LEDs, or OLEDs) are solid-state semiconductor devices that convert electrical energy into electromagnetic radiation that includes visible light. An LED typically comprises a chip (die) of a semiconducting material doped with impurities to create a p-n junction. The LED chip is electrically connected to an anode and cathode, all of which are often mounted within a package. In comparison to other lamps such as incandescent or fluorescent lamps, LEDs emit visible light that is more directional, in a narrower beam. Advances in LED technology have enabled high-efficiency LED-based lighting systems to find wider use in lighting applications that have traditionally employed other types of lighting sources, including more omnidirectional lighting applications previously served by incandescent and fluorescent lamps. As a result, while LEDs have traditionally found uses in applications such as automotive, display, safety/emergency, and directed area lighting, LEDs are increasingly being used for area lighting applications in residential, commercial and municipal settings.

FIG. 1 represents a nonlimiting commercial example of an LED-based lighting unit suitable for area lighting applications. Specifically, the lighting unit (hereinafter, lamp) 10 is represented as a General Electric Energy Smart® LED bulb or lamp (ANSI A19 type) configured to provide a nearly omnidirectional lighting capability. LED-based lighting units of various other configurations are also known. As represented in FIG. 1, the lamp 10 comprises a transparent or translucent cover or enclosure 12, an Edison-type threaded base connector 14, a housing or base 16 between the enclosure 12 and the connector 14, and heat-dissipating fins 18 that enhance radiative and convective heat transfer to the surrounding environment. An LED-based light source (not shown), typically an LED array comprising multiple LED devices, is located at the lower end of the enclosure 12 adjacent the base 16. The LED devices may be mounted on a printed circuit board (PCB) mounted to or within the base 16, and may be encapsulated on the PCB, for example, with a protective cover (not shown), often formed of an index-matching polymer to enhance the efficiency of visible light extraction from the LED devices. The lamp 10 may further comprise a lens (not shown) within the enclosure 12 to affect the light distribution from the lamp 10. Driving electronics convert A.C. power received at the connector 14 to a form suitable for driving the LED devices, though this function would be omitted if the LED devices are configured to be operated directly from the power received at the connector 14.

An LED device within the lamp 10 will often comprise a dome that serves as an optically transparent or translucent envelope enclosing the LED chip. Because LEDs emit visible light in narrow bands of wavelengths, for example, green, blue, red, etc., combinations of different LEDs are often combined in LED lamps to produce various light colors, including white light. A phosphor may also be used to emit light of color other than what is generated by an LED. For this purpose, the inner surface of a dome enclosing an LED chip may be provided with a coating that contains a phosphor composition, in which case electromagnetic radiation (for example, blue visible light, ultraviolet (UV) radiation, or near-visible ultraviolet (NUV) radiation) emitted by the LED chip can be absorbed by the phosphor composition, resulting in excitation of the phosphor composition to produce visible light that is emitted through the dome.

Portions of LED lamps, including the enclosure 12, base 16, fins 18, protective LED cover, and/or lens of the lamp 10 represented in FIG. 1, are often formed of polymer materials. Polycarbonate (PC) is one such material due to its low weight, high impact resistance, light transmissivity, flame retardance, and cost. However, certain properties of polycarbonate are less than optimal for LED lamp applications, for example, scratch resistance, optical dispersion coefficient, and light transmission from NUV to near-visible infrared (NIR). Though acrylate polymers are noted for their light transparency, resistance to breakage, and elasticity, they may not exhibit sufficient flame retardance to meet industry standards, for example, UL (Underwriter Laboratories, Inc.) and CE (Conformité Européenne) standards, particular those required for protective LED covers and lenses of LED lamps.

Fire retardance of polymers is typically measured by what is termed the limiting oxygen index (LOI) (ASTM D2863), which is the minimum concentration of oxygen in a flowing mixture of oxygen and nitrogen that will support combustion. LOI is expressed as a percentage, with higher values corresponding to polymers that require more oxygen to combust and are therefore less flammable and more fire retardant. Whereas polycarbonates typically have an LOI of approximately 25%, which is acceptable for LED applications, acrylates typically have a lower LOI, for example, approximately 17%.

It would be advantageous if a polymer were suitable for use in an LED lamp that provided flame retardance and potentially other desirable properties associated with polycarbonates, yet was also capable of exhibiting improved optical dispersion and light transmission characteristics, for example, transparency to electromagnetic radiation that includes visible light and preferably also UV wavelengths.

### BRIEF DESCRIPTION OF THE INVENTION

The present invention provides polymer materials that are capable of use in lighting systems, for example, optically transparent or translucent portions of an LED-based lighting system.

According to one aspect of the invention, a lighting system includes a light source that generates electromagnetic radiation including visible light and/or ultraviolet radiation, and a molded component comprising an optically translucent or transparent acrylate-fluoro copolymer or blend comprising a fluoropolymer and an acrylate polymer. The acrylate polymer has a visible light total transmissivity that is less than that of the fluoropolymer, and each of the fluoropolymer and the acrylate-fluoro copolymer or blend has a limiting oxygen index that is higher than that of the acrylate polymer.

According to further aspects of the invention, the acrylate-fluoro copolymer or blend may contain 30 weight percent or less of the fluoropolymer, in which case the visible light total transmissivity of the copolymer material or blend is promoted as a result of being greater than that of the acrylate polymer. Alternatively, the acrylate-fluoro copolymer or blend may contain more than 30 weight percent of the fluoropolymer, in which case the visible light diffusivity properties of the copolymer material or blend are promoted as a result of being greater than that of the acrylate polymer.

A technical effect of the invention is the ability of the component to exhibit various properties desirable for lighting systems, including LED-based lamps, for example, light transmissivity and flame retardance required for certain applications in LED lamps.

Other aspects and advantages of this invention will be better appreciated from the following detailed description.

### BRIEF DESCRIPTION OF THE DRAWINGS

FIG. 1 represents an LED-based lighting unit.

FIG. 2 schematically represents a cross-sectional view of an optically translucent or transparent portion of the lighting unit of FIG. 1.

### DETAILED DESCRIPTION OF THE INVENTION

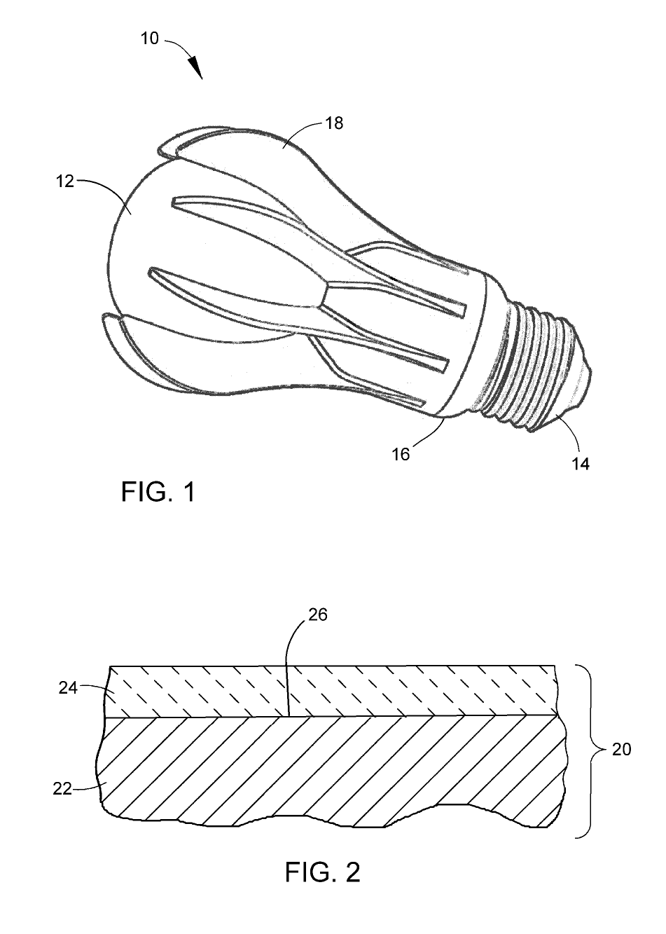

The present invention provides an acrylate-based copolymer or blend having properties that result in the copolymer or blend being desirable for use in lighting systems, a nonlimiting example of which is the LED lamp 10 represented in FIG. 1. Because the representation of the lamp 10 is useful for discussing a type of lighting system with which the present invention can be practiced, further references will be made to the lamp 10 in the following discussion, though it should be understood that the invention is not limited to the particular configuration of the lamp 10 or to light-generating devices in general.

One aspect of the invention is an acrylate-fluoro copolymer material or blend capable of being molded to produce at least a portion of an optically translucent or transparent component of the lamp 10 through which passes electromagnetic radiation (including, e.g., visible light and/or UV wavelengths) generated by one or more LED chips within the lamp 10. Nonlimiting examples of such components include the enclosure 12 of the lamp 10, a lens within the enclosure 12, or a protective LED cover that encloses one or more LED chips within the lamp 10. The copolymer material or blend is predominantly and preferably entirely an acrylate polymer combined with a fluoropolymer having a greater limiting oxygen index (LOI) than the acrylate, for example, greater than 17%. Another aspect is a method of producing a molded component of the acrylate-fluoro copolymer material or blend, wherein the component is optically translucent or transparent, including transparency to visible light and UV radiation. The copolymer material or blend benefits from certain properties of the acrylate polymer and the fluoropolymer. For example, the acrylate polymer fraction of the copolymer material or blend preferably exhibits lower visible light and UV total transmissivity relative to the fluoropolymer, and reduces the optical dispersion coefficient of the copolymer material or blend to something less than that of the fluoropolymer. The acrylate polymer fraction of the copolymer material or blend may also has the capability of increasing the scratch resistance of the copolymer material or blend to something greater than possible with the fluoropolymer alone. Another desirable aspect of the acrylate polymer is the ability to achieve high purities with raw materials and polymerization reaction associated with acrylate polymers. On the other hand, though fluoridation the fluoropolymer fraction of the copolymer material or blend improves flame retardance (FR) and increases LOI to something greater than possible with the acrylate polymer alone, preferably sufficient to meet ASTM D2863 standards for LED applications.

The acrylate polymer is preferably a methacrylate, and the fluoropolymer is preferably a vinyl fluoride. Polymethyl methacrylate (PMMA) is believed to be a preferred methacrylate and polyvinylidene fluoride (PVDF) is believed to be a preferred vinyl fluoride for use with the invention. PMMA and PVDF are completely miscible when molten and capable of being combined to produce a homogenous mixture, such that the acrylate polymer and fluoropolymer can be uniformly distributed throughout the molten mixture. By combining the PMMA and PVDF in their molten states, it is believed that the optical grade transparency of PMMA is not degraded or otherwise affected by the addition of PVDF. Furthermore, it is believed that as long as the mixture does not contain more than 30% PVDF by weight, the resulting acrylate-fluoro copolymer material or blend is capable of exhibiting desirable optical transparency with minimal haziness (as perceived by an average human eye), preferably equal to that of PMMA alone, in which case the visible light total transmissivity of the acrylate-fluoro copolymer material or blend is promoted and ranges from greater than that of PMMA up to that of PVDF. As such, embodiments in which the acrylate-fluoro copolymer material or blend contains up to 30% PVDF by weight are particularly suitable for use as optical lens materials. With higher concentrations of the fluoropolymer, the acrylate-fluoro copolymer material or blend exhibits increased light diffusion characteristics, visually detectable as a hazier light, as compared to that of PMMA alone, yet its visible light total transmissivity ranges from greater than that of PMMA up to that of PVDF. As such, embodiments in which the acrylate-fluoro copolymer material or blend contains more than 30% PVDF by weight are particularly suitable for use as an optical diffuser material. In either case, the resulting acrylate-fluoro copolymer material or blend finds applications in lamps, including LED lamps.

According to a particular embodiment of the acrylate-fluoro copolymer material or blend, the addition of up to about 30 weight percent of the fluoropolymer in the copolymer material or blend, and more preferably at least 10 to about 30 weight percent, retains the visible light total transmissivity properties of the acrylate polymer so as to be suitable for optical lens applications while also being capable of contributing significant fire retardance properties. As a nonlimiting example, based on PVDF having an LOI of about 40% and PMMA having an LOI of about 17%, a copolymer material or blend which is evenly blended to contain PVDF and PMMA at a 30:70 ratio will have an LOI of about 24%, which approximates the LOI of polycarbonate (about 25%). According to another particular embodiment, the acrylate-fluoro copolymer material or blend contains in excess of 30 weight percent of the fluoropolymer, and preferably at least 30 to about 70 weight percent fluoropolymer, to achieve light diffusivity properties greater than that of the acrylate polymer and suitable for light-diffusing enclosure applications. In this embodiment, the LOI of the acrylate-fluoro copolymer material or blend is also increased by the higher content of the fluoropolymer in the acrylate-fluoro copolymer material or blend. As a nonlimiting example, based on PVDF having an LOI of about 40% and PMMA having an LOI of about 17%, a copolymer material or blend which is evenly blended to contain PVDF and PMMA at a ratio of about 50:50 will have an LOI of about 29%, which is greater than the LOI of polycarbonate (about 25%). A desirable range for the LOI of the copolymer material or blend is believed to be greater than 17% to about 35%.

The acrylate polymer and fluoropolymer are preferably uniformly mixed in a molten state, and the resulting molten mixture is used to produce a molded component 20, schematically represented in FIG. 2. According to another aspect, a coating 24 may be applied to a surface 26 of a substrate region 22 of the component 20 formed of the copolymer material or blend. As a non-limiting example, the coating 24 may comprise a combination of fluoro-base monomers, oligomers, and/or polymers to provide the additional benefit of further delaying oxygen diffusion into the component 20 during combustion. Such a coating 24 preferably has a thickness of at least 0.5 micrometer, and possibly as high as about 10 micrometers, to provide the desired effect. In this embodiment, the flame retardance of the component 20 can be further increased beyond that possible without the coating 24, without a significant reduction of the advantages of the copolymer material or blend, especially high optical transparency attributable to its acrylate content.

As previously noted, in certain embodiments of the invention the copolymer material or blend can be used to form components of a light-generating unit, for example, the LED lamp 10 of FIG. 1. As nonlimiting examples, the copolymer material or blend may be used to form a protective cover that encloses the LED devices within the lamp 10, and/or a lens within the enclosure 12 that affects the light distribution from the lamp 10. In both of these applications, in which visible light and NUV and/or NIR radiation generated by an LED device passes through the component, the copolymer material or blend is able to provide advantages characteristic of the acrylate polymer, including transparency to visible light and UV wavelengths, while also exhibiting improved flame retardance resulting from the inclusion of the fluoropolymer.

While the invention has been described in terms of specific embodiments it is apparent that other forms could be adopted by one skilled in the art. Therefore, the scope of the invention is to be limited only by the following claims.

1. A lighting system comprising:
a light source that generates electromagnetic radiation including visible light or ultraviolet radiation; and
a molded component comprising an optically translucent or transparent acrylate-fluoro blend or an optically translucent or transparent acrylate-fluoro copolymer.

2. The lighting system according to claim 1, wherein the molded component comprises an optically translucent or transparent acrylate-fluoro blend comprising a fluoropolymer and an acrylate polymer, wherein each of the fluoropolymer and the acrylate-fluoro blend has a limiting oxygen index that is higher than a limiting oxygen index of the acrylate polymer.

3. The lighting system according to claim 2, wherein the acrylate polymer has a visible light total transmissivity that is lower than a visible light total transmissivity of the fluoropolymer.

4. The lighting system according to claim 2, wherein the acrylate-fluoro blend comprises less than about 30 weight percent of the fluoropolymer and a balance essentially of the acrylate polymer, and the acrylate-fluoro blend has a visible light total transmissivity greater than that of the acrylate polymer.

5. The lighting system according to claim 4, wherein the fluoropolymer constitutes about 10 to about 30 weight percent of the acrylate-fluoro blend by weight.

6. The lighting system according to claim 2, wherein the acrylate-fluoro blend comprises about 30 weight percent to about 70 weight percent of the fluoropolymer and a balance essentially of the acrylate polymer, and the acrylate-fluoro blend has visible light diffusivity properties greater than that of the acrylate polymer.

7. The lighting system according to claim 2, wherein the acrylate polymer comprises a methacrylate.

8. The lighting system according to claim 7, wherein the methacrylate is polymethyl methacrylate.

9. The lighting system according to claim 2, wherein the fluoropolymer comprises vinyl fluoride.

10. The lighting system according to claim 9, wherein the vinyl fluoride is polyvinylidene fluoride.

11. The lighting system according to claim 1, wherein the limiting oxygen index of the acrylate-fluoro copolymer or acrylate-fluoro blend is greater than 17% to about 35%.

12. The lighting system according to claim 1, wherein the component has a surface defined by a surface region thereof, and a coating overlying the surface, the coating containing a combination of fluoro-base monomers, oligomers, and/or polymers and delays oxygen diffusion into the surface region during a combustion.

13. The lighting system according to claim 1, wherein the lighting system is a light-emitting diode lamp.

14. The lighting system according to claim 13, wherein the component is a protective cover that encloses a light-emitting diode within the lamp or a lens within the lamp.

15. A lighting system comprising:
a light-emitting diode that generates electromagnetic radiation including visible light or ultraviolet radiation; and
a molded component comprising an optically translucent or transparent acrylate-fluoro copolymer or blend comprising 30 weight percent or less of a fluoropolymer and the balance essentially an acrylate polymer, wherein the acrylate polymer has a visible light total transmissivity that is lower than a visible light total transmissivity of the fluoropolymer, the acrylate-fluoro copolymer or blend has a visible light total transmissivity greater than that of the acrylate polymer, and each of the fluoropolymer and the acrylate-fluoro copolymer or blend has a limiting oxygen index of greater than 17% and is higher than a limiting oxygen index of the acrylate polymer.

16. The lighting system according to claim 15, wherein the fluoropolymer constitutes at least 10 to 30 weight percent of the acrylate-fluoro copolymer or blend, by weight.

17. The lighting system according to claim 15, wherein the acrylate polymer is polymethyl methacrylate and the fluoropolymer is polyvinylidene fluoride.

18. A lighting system comprising:
a light-emitting diode that generates electromagnetic radiation including visible light or ultraviolet radiation; and
a molded component comprising an optically translucent or transparent acrylate-fluoro copolymer or blend comprising more than 30 weight percent of a fluoropolymer and the balance essentially an acrylate polymer, wherein the acrylate polymer has a visible light total transmissivity that is lower than visible light total transmissivities of each of the fluoropolymer and the acrylate-fluoro copolymer or blend, the acrylate-fluoro copolymer or blend has visible light diffusivity properties greater than that of the acrylate polymer, and each of the fluoropolymer and the acrylate-fluoro copolymer or blend has a limiting oxygen index of greater than 17% and is higher than a limiting oxygen index of the acrylate polymer.

19. The lighting system according to claim 18, wherein the fluoropolymer constitutes more than 30 to about 70 weight percent of the acrylate-fluoro copolymer or blend by weight.

20. The lighting system according to claim 18, wherein the acrylate polymer is polymethyl methacrylate and the fluoropolymer is polyvinylidene fluoride.
